(19) United States
(12) Patent Application Publication
(10) Pub. No.: US 2010/0274717 A1
(43) Pub. Date: Oct. 28, 2010

(54) Global Internet Based Method and System For Compiling, Assigning, Registration, and Maintenance of Unique Tags

(76) Inventor: Shaun Wright, Houston, TX (US)

Correspondence Address: LAW OFFICE OF DAVID MCEWING, P.O. BOX 70410, HOUSTON, TX, 77270, US

(21) Appl. No.: 12/428,238

(22) Filed: Apr. 22, 2009

(51) Int. Cl. G06Q 40/00; G06F 17/30; G06Q 10/00

(52) U.S. Cl. 705/44; 705/39; 707/E17.044; 705/1.1

(57) ABSTRACT

A method and process of a Registrar creating unique Equipment Tags for use of one or more Equipment owners wherein there is no duplication of Tags among the participating Equipment owners. The Equipment owner requests the Tag and its registration as a service over the Internet or other network in the same way as a Client might request a URL from a domain registration agency. The Registrar receives payment in exchange for receiving the exclusive right to use the Tags from the Registrar's System. The Tags are the product of the Registrar's System. The processor may utilize a Tag generator. The Tags are generated upon instruction of software operating on the computer processor. The Tags may be issued for an identified piece of Equipment. Information regarding the Equipment may be entered on the Tag Register. The Tag and Equipment information is stored in the Tag Register interfacing with the computer processor. The Equipment owner receives exclusive use of the Tag for a fixed period of time. The Equipment owners interface with the System over the Internet or other network.

### BACKGROUND OF INVENTION

1. Field of Use

The invention provides a System for generating Tags for Clients' Equipment, over the internet or other network. Each assigned Tag will be unique in the Registrar's Tag Register. At the Client's request over the internet, the Tags will be generated by a unique Tag generator or similar device interfacing with the System's computer processor and software. These Tags will then be licensed to the Clients for a registration fee for a specified period of time, and will be stored, along with other optional Equipment data, in one or more computer readable Tag Registers interfacing with the software embedded on the processor, for as long as the maintenance fee is paid. The registration fee, maintenance fee, and quantity and type of Tags will be specified in the Contract.

2. Related Uses

Many Clients have, over time, created competing, duplicate, or separate property identification systems. The result is that, for example, a single item of Equipment may be concurrently identified by multiple names or Tags, causing confusion in the designated uses of that Equipment.

### SUMMARY OF INVENTION

### Definitions:

Equipment: meaning any physical equipment, property or asset (Parent), or component parts of that physical equipment, property or asset (Children).
Tag: is a unique System or product generated, assigned and managed Tag. A Tag is used to uniquely identify a piece of Equipment owned by anyone and located anywhere in the world.
System: comprises a global, internet based business method and computer processor based system, including but not limited to databases, for compiling, assigning, registration, and maintenance of Tags over the internet or any network for any Client.
Client: comprises any corporation, individual, organization or other entity owning, managing, operating or in any way responsible for Equipment.
Contract: Agreement between Client and Registrar defining the terms and conditions of the business method including but not limited to registration fee per Tag, maintenance fee per Tag, term of the agreement and license and any other information comprising the agreement.
Registrar: comprises the owner or operator of the System.
Client Register: database comprising Client identification information.
Contract Register: database comprising Contracts.
Tag Register: database comprising Tags.
Pre-commit Tag Register: database comprising Tags for which the Client has yet to pay the registration fee
Delinquent Tags Register: database comprising Tags for which the Client has lapsed the maintenance payment.

The invention pertains to a computer driven business method and system for the Registrar to compile, assign and license Tags to its Client's Equipment for a registration fee, plus a maintenance fee, for as long as the maintenance fee is paid. The Tags allow the Client to manage its Equipment. Each Tag will identify a discrete piece of Equipment. As will be demonstrated, each Tag will be certified by the Registrar as unique in the Registrar's System. Each Tag will be unique from all other Tags assigned by the Registrar. No piece of Equipment will ever be assigned more than one Tag, and once assigned, no other piece of Equipment will ever be assigned that Tag. No Clients will ever be assigned the same Tag for different pieces of Equipment.

The primary objective of the invention is to license Tags, for a specified period of time, for a fee. At the end of the specified period, the Client can renew the license for an extended period of time by the payment of the maintenance fee or, alternatively surrender the Tag.

Another objective is to allow the Client to access the Registrar's computer processor interfacing with a Tag generator or other device through the Internet to obtain Tags and pay the appropriate registration fee. The Registrar thereby allows a Client to manage the identification, location and use of the Equipment. The Registrar's processor interfaces with a Tag generator and Tag Register.

A further objective is to utilize a Tag generator or other Tag selection system and interfacing the Tag generator with the software embedded on a processor and at least one server as a Register storing the Tags and optional Equipment information. In addition, the System is used to issue and control the assignment of Tags. The Registrar's control of this method and operation of the System allows any participating Client to be sure that the Tags issued for their particular Equipment will be unique to that Equipment. The Equipment can be clearly identified without risk of ambiguity or confusion in documents, programs, maps, or in any other form of reference and no matter where it is located in the world.

This certainty of an identification Tag exclusively representing known Equipment will be achieved by the Registrar maintaining a Tag Register. Preferably the Tag Register will be maintained on one or more servers. Multiple Tag Registers may be maintained. The Tag Register stores information regarding the Equipment, the Equipment's Tag as well as optional additional information such as Equipment description, Equipment type, Client, Equipment Location, date of registration etc., as may be requested or inserted by the Client or otherwise generated.

The Client may mark the Equipment with the assigned Tag. The Client may also combine the Tag with inventory control systems. For example, the Client may have the Tag encoded on an RFID device affixed to the Equipment. The amount of Equipment information disclosed to the Registrar may be discretionary to the Client. The Client may choose to map the Tag to its own internal Tag or naming system.

As used in this invention disclosure, comprising means including the listed elements but not excluding other elements. Further, “program code” is used synonymously with “software”.

### SUMMARY OF DRAWINGS

The accompanying drawings, which are incorporated by reference and constitute part of the specification, illustrate preferred embodiments of the invention. These drawings, together with the general description of the invention given above and the detailed description of the preferred embodiments given below serve to explain the principles of the invention.

FIG. 1.0 illustrates the process steps of software for the Client registration and logon procedure for accessing the System.

FIG. 2.0 illustrates the steps and product of Tag generation and the placement of the generated Tags in the Pre-Commit Tag Register.

FIG. 3.0 illustrates the payment step and transfer of the tag from the Pre-Commit Register to the Tag Register.

FIG. 4.0 illustrates the steps in assessing and invoicing Clients for Maintenance Fees.

FIG. 5.0 illustrates the steps in transferring Tags subject of delinquent maintenance payments to the Delinquent Tags Register.

### DETAILED DESCRIPTION

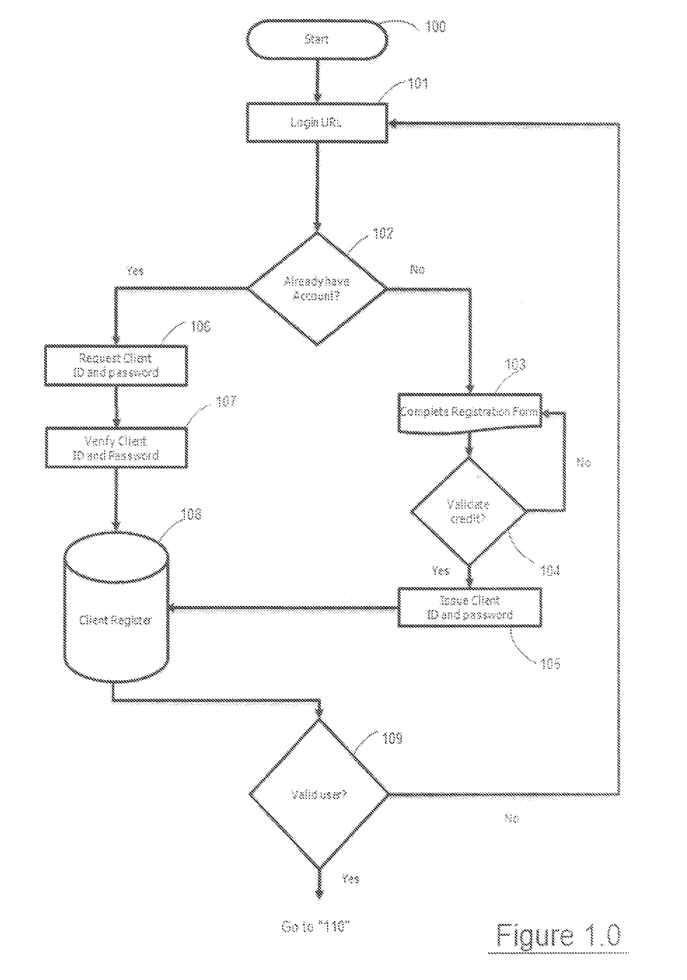

The System described herein comprises a Tag Register with a Tag generator or other programmed method for the issuance of Tags for Equipment interfacing with a computer processor and at least one server for a Tag Register. In one embodiment, the server may have 4 terabytes. The computer processor is also embedded with software that carries out the functions of the invention; an embodiment is illustrated in FIGS. 1.0 through 4.0. The System operates through the software. The System includes a data input wherein the software can read computer readable data and data that's been manually inputted via a Human Machine Interface (HMI). There can also be an output such as a file, monitor, printer or other form of report.

The business method of the invention further comprises payment from each Client licensing Tags from the Registrar for a stipulated period of time. A Client may license thousands, tens of thousands or more of Tags from the Registrar. The Client receives the exclusive right to use the Tag(s) issued by the Registrar's System. The business method also includes the Register performing maintenance for the Tags. This maintenance includes periodically verifying that each Tag is unique. It may also include verifying that the Equipment description on any Register is consistent with other Registers.

The Registrar's System will interface with the Internet or other network to allow Clients to have access to the System to acquire Tags and pay the registration and maintenance fees to the Registrar. The System will have safeguards to prevent unauthorized alteration of the Registrar's Registers. These could include but are not limited to prevention of a remote computer gaining access to stipulated Registers, and limited functionality of the processor and software in response to commands from a remote computer.

The System may instruct the Tag generator to issue and communicate a Tag to a Client. Alternatively, the System may be instructed to issue a Tag using another procedure to select or generate a Tag. In either situation, the issued Tags will be unavailable for any other Equipment.

The Tag generator may use computational algorithms that can automatically create long runs (for example, millions of Tags). An example is a linear congruential generator.

An issued Tag is immediately registered and is unavailable to be assigned to other Equipment. This step ensures that the Tag does not reappear as the identifier of other Equipment of the Client or for Equipment of another Client. For reasons explained below, possessing Tags is of great value to Clients.

Other embodiments do not require the generation of Tags. For example, Tags can be selected in sequential order, but modified by the hierarchal order of the Equipment. For example, Child Equipment that may fit within a Parent category may have a Tag selected from a different sequential string for Equipment fitting within the Parent category. Parent Equipment may be the principal structure and Child Equipment may be the numerous Equipment pieces that may have no function other than to service the Parent Equipment. Using this analogy, there may be several generations comprising the hierarchal order. There may be Equipment whose role is not limited to serving the Parent Equipment. Other Equipment may have nothing to do with the Parent.

The System will be accessible via the Internet or other network. This allows Clients to access the System to receive Tags or, for example, at the Registrar's discretion, add information to the description or location of Equipment within the Tag Register used by that Client, and located on the Registrar's servers. This process would utilize the Registrar's software embedded on the processor.

There are many industries in which individual companies have extensive inventories of Equipment scattered in diverse locations. Some companies within an industry have unintentionally created conflicting identification systems. Therefore, within a single company, it may be difficult for employees to know if they are communicating with other employees about the same Equipment. A single piece of Equipment may have one identifier for tax and accounting purposes, a different identifier for inventory control, and a different identifier for the production or operations group. Further outside vendors to the company likely have their own descriptors of the same equipment. Hereinafter all known as Multi-Descriptors.

One industry that is burdened with Multi-Descriptors as described in the preceding paragraph is, for example and not restricted to, the oil and gas industry. Some companies have large inventories of valuable Equipment scattered on production and drilling platforms and oil and gas fields and drill sites worldwide. Any given instance of these may be known by multiple names within differing groups of both the Equipment owner, and the industry in general. A unique and independently managed, licensed and certified identifier would be a significant global organizational improvement.

For example, all of the Equipment at a given site can be identified using the invention. For example the individual pieces of a drill string (some of which comprise multiple miles in aggregate) can be identified. The age or production history of individual sections of the drill string could be tracked by the Client to determine when Equipment should be retired from service. Further the Client may access the System and update information on Equipment location listed in the Tag Register. Consumable or lost Equipment may also be removed from the Tag Register and the Tag may be made available to the System for reassignment.

Further examples of oil and gas Equipment that may be assigned Tags include but are not limited to down hole sensors and tools, pumps, heat exchangers, compressors, valves, generators, motors, pipelines, manifolds, process units, and controllers.

An additional function of the System is the correlation of each Tag to the receipt of current payments from the associated Client. The participating Client licenses the exclusive use of one or more Tags through the Registrar. The exclusive use is for a stipulated period of time. To continue the exclusive use of the Tag(s), the Client pays a maintenance fee to the Registrar. The Tags, name and address of the Client, plus the terms of the exclusive use and charges for this use will be set forth in the Contract. For example, the System can list all Tags having a term that will expire within 45 days. The System can compile the name and address of Clients with pending or delinquent payments. The System can contact these Clients via a network regarding the impending expiration dates or delinquencies. The System can electronically debit credit cards or debit cards or standing purchase orders of the Client and update the expiration dates of the subject Tags.

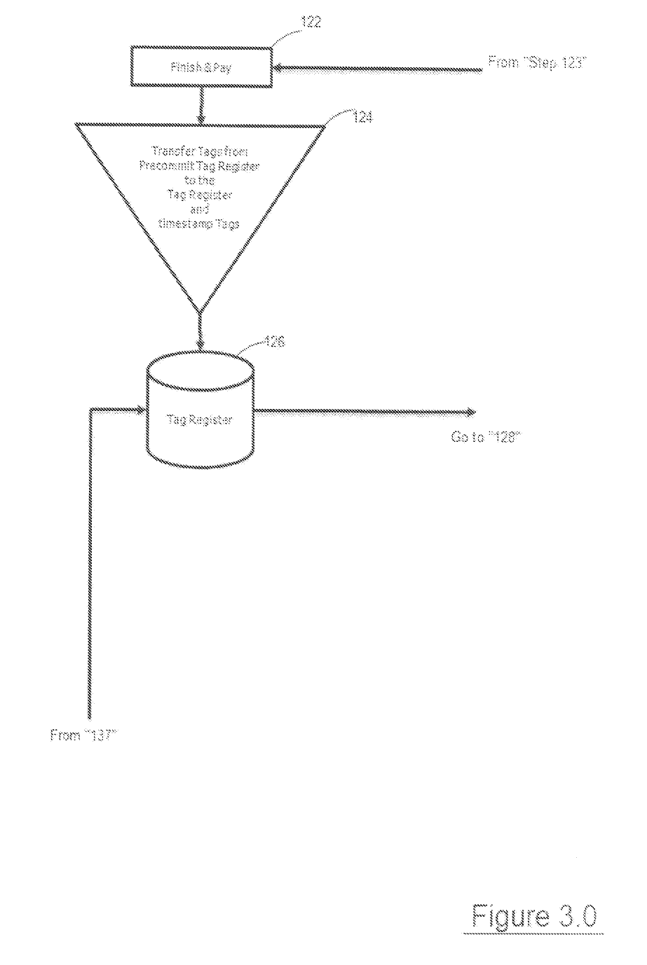

FIGS. 1 through 5 illustrate one embodiment of the invention, i.e., the issuance of Tags and the assessment and collection maintenance fees that accrue under the Contract. The System is accessible via the Internet or other network. The Client may start 100 the process of obtaining one or more Tags by entering the Registrar's URL address 101. The Client is immediately queried 102 as to whether he already possesses an account. If responding affirmatively, his entered user id 106 is verified 107.

If the Client states 102 that he does not have a user account, he is requested to complete a registration form 103. The next step 104 is to validate the Client's credit, i.e., does he possess a purchase order or Contract for the licensing of Tags? If determined to be credit worthy, a Client ID and password is issued to the Client 105.

The Client's information is inputted into the Client Register 108. Similarly, a Client already possessing an account is also vetted by the Client Register. If the Client does not pass the scrutiny 109 of the Client Register as a valid user, the Client's progress through the System is terminated and the Client is returned to the log in step 101.

Assuming the Client is validated; the step 110 pertains to Tag generation utilizing authorized account information incorporated as the first part of the Tag. For example it could be the name for the Client. Step 111 allows the Client to add supplemental information as part of the Tag generation process. The Client may enter a description of the Equipment or Equipment location or other details as required.

The next question 112 for the Client is whether the Client is intending to license one Tag or multiple Tags. If intending to license multiple Tags, the Client goes to 113, where an interactive screen can be used by the Client to enter the number and type of multiple Tags to be generated. If the Client adds “Parent” Equipment, e.g., a well, and wants to auto-generate multiple dependent Tags “Children”, e.g., valves, the System auto-generates the Client specified Tags. The multiple number generator step 115 entails the generation of multiple unique Tags through use of a counter 117 and generator.

The next step 117 pertains to the use of a counter to verify the correct quantities of Tags have been generated. The Tags are added 118 to a Pre-commit Tag Register 118. The Tags are stored in the Pre-commit Tag Register until payment is confirmed 116. There is a query 119 whether the Client is finished. If not, the Client returns to 113.

If the Client states he wants only a single Tag, 112, the next step is the generation of a Tag by the Tag generator 114. Again the Tag is stored in the Pre-commit Tag Register, 116. The Client can then elect to check out, e.g., add the Tag to a cart 120. The Client can elect to repeat the process 121 by going back to 110.

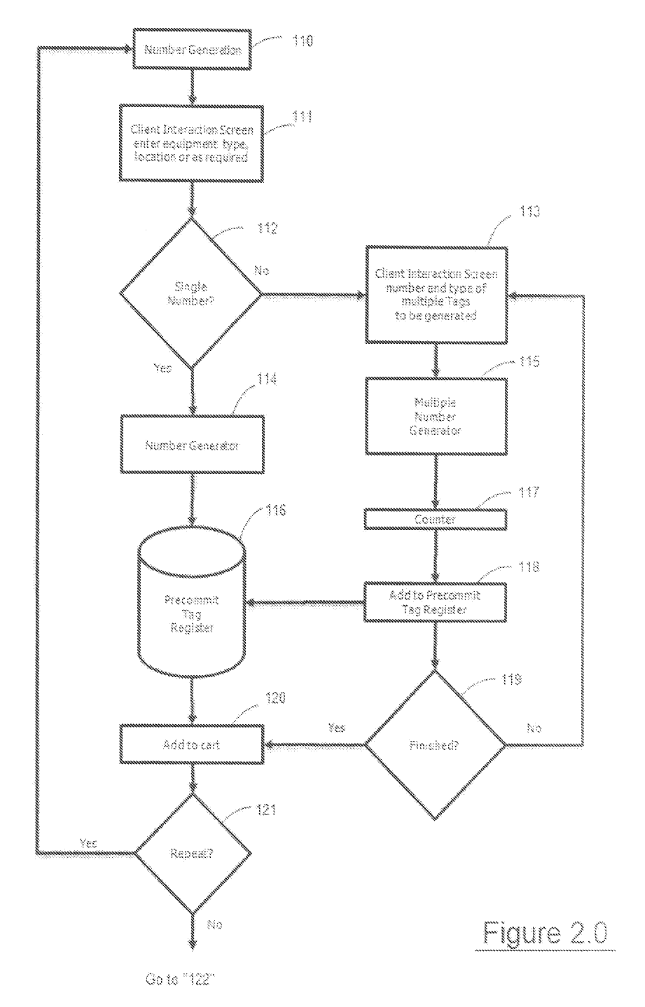

The Client can finish and pay 122. This step confirms payment. 124 then transfers the Tags from the Pre-commit Tag Register to the Tag Register 126. See FIGS. 2.0 and 3.0.

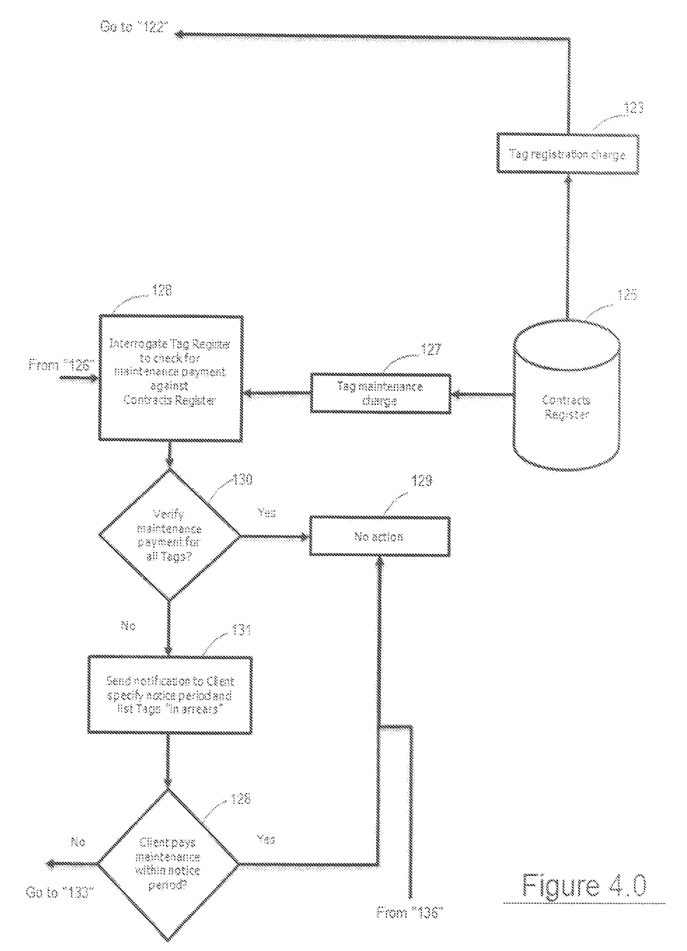

FIG. 4.0 illustrates the next step performed by the System is to search the permanent Tag Register to check for maintenance payments against date and Client Contracts Register 125. Step 130 verifies maintenance payments paid for all Tags. If payment has been made, no further action is to be taken 129. However if payment has not been made 131 notification is sent to the Client specifying the notice period before default on the license commitment.

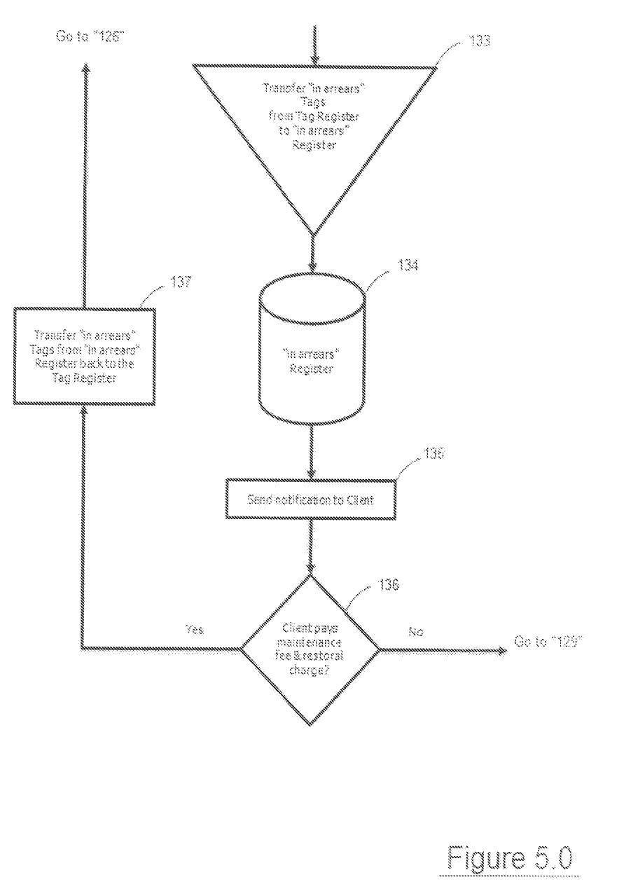

FIG. 5.0 illustrates if the Client does not pay the maintenance fee during the notice period 128, the Tag is transferred 133 from the permanent Tag Register to the Delinquent Tag Register 134. Notification of this transfer is sent to the Client. If the Client now pays the maintenance fee and possible renewal charge 136, the Tag is transferred from the Delinquent Tag Register 137 to the permanent Tag Register 126.

If the Client pays the maintenance fee within the notice period 128, no further action needs to be taken 129.

There is also a Client Contracts Register. Information from this Register can be interrogated for Tag registration and maintenance charges 127 and this information can be supplemental to interrogating the permanent Tag Register to check for maintenance payment dates and Client Contracts 128. The Client Contracts Register can also provide information of Tag registration charges 123.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the business method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

The specific embodiment described here concerns the oil and gas industry, but this is by way of illustration only. The system can be used by the owners of Equipment used in all types of industries. By way of further example and not limitation, these could include the medical industry and hospital Equipment, the construction industry, the transportation industry with moving Equipment such as planes, trains, and boats, the real estate industry, all of the manufacturing industries, and the military.

1. A method of identifying Equipment wherein a piece of Equipment is assigned a Tag comprising the steps of:
a) computer readable software embedded on a processor receiving instructions to assign a Tag correlated to an identified Client;
b) the software instructing a unique Tag generator to generate a Tag;
c) the software instructing the processor to verify the Tag is unique by interrogating at least one Register;
d) the software receiving the input from the processor that the Tag does not duplicate a Tag in the Register;
e) the software instructing the Register to add the Tag and correlate the Tag to the identified Client.

2. The method of claim 1 further comprising:
a) a Client providing information regarding the Equipment in computer readable form to the processor; and
b) the Equipment information read by the software and stored on a Register with the assigned Tag and Client's name.

3. The method of claim 1 further comprising:
a) using a computer Tag generator and computer readable software and a server as a computer readable Register to assign a Tag to Equipment;
b) providing the Tag to the Client;
c) entering information comprising the Equipment description and Tag in a computer readable Register; and
d) the software periodically instructing Register to verify that the Tag is unique in the Register.

4. The method of claim 1 further comprising a step further comprising the embedded computer readable software instructing the processor to verify the product of the Tag generator has not been assigned to other Equipment.

5. The method of claim 1 further comprising providing descriptive information for multiple pieces of Equipment in computer readable format to the software and the Registrar using a computer Tag generator to create and assign a Tag to each Equipment description.

6. The method of claim 3 further comprising using the processor with embedded software and Register for periodic maintenance of assigned Tags and comprising reports of the Register listing Tags and information of the piece of Equipment assigned to each Tag.

7. The method of claim 1 wherein the Tag is not communicated to the Client until payment for the term of exclusive use of the Tag is made.

8. The method of claim 1 wherein the Client communicates with the System through the Internet or other network.

9. The method of claim 1 further comprising using the processor with a Tag generator and software to assign Tags to a plurality of Equipment utilizing a predetermined hierarchy of Equipment.

10. The method of claim 9 wherein the Equipment comprises at least one of an oil well, a gas well, production tubing, Christmas tree assembly, down hole sensors, drill motor or drill bits and the Tags are assigned by the computer in a hierarchy wherein the oil or gas well is the Parent and other equipment are the Children.

11. The computer program product of claim 9 further comprising:
a) the Client entering the Equipment description or Equipment location in computer readable form to the processor; and
b) the software instructing the Equipment description or Equipment location be correlated to the Equipment Tag and entered in a computer readable Tag Register.

12. The computer program method of claim 9 further comprising:
a) the Client transmitting a payment to the Registrar in exchange for exclusive use of the Tag for a term; and
b) the software instructing a Register to record the payment and term with the Equipment Tag.

13. A computer program product, comprising a computer usable medium having a computer readable program code embedded therein, said computer readable program code adapted to be executed to implement a method for identifying a piece of Equipment by a Tag, said method comprising the program code:
a) asking a Client the quantity of Tags needed;
b) instructing a computer Tag generator to generate the needed Tags;
c) instructing the Tag generator to transmit the Tags to a Register to validate the uniqueness of the Tag; and
d) instructing the processor to transmit the Tags to the Client.

14. The computer program product of claim 13 comprising:
a) instructing the computer readable Register to search for all exclusive use terms expiring within a stipulated time;
b) receiving the search result from the Register; and
c) instructing the processor to notify the Clients possessing exclusive use of a Tag expiring within a defined time.

15. A computer program product comprising a computer usable medium having a computer readable program code embedded therein, said computer readable program code adapted to provide Tags to Clients for a stipulated time for a fee, said method comprising the program code:
a) entering a login url as part of a logon step;
b) verifying Client utilizing a Client Register;
c) Client inputting information comprising Company name, Equipment type and Equipment location;
d) Client specifing quantity of Tags or the System auto generating the quantity of Tags;
e) instructing Tag generator to provide Tags;
f) communicating Tags to program code;
g) System storing Tags in Pre-commit Tag Register;
h) Client paying for Tags; and
i) System transfering Tags from Pre-commit Tag Register to permanent Tag Register.

16. The computer program product of claim 15 further comprising
a) System interrogating permanent Tag Register;
b) System verifiing payment status for all Tags;
c) notification listing Tags sent to non-paying Clients; and
d) System interrogating Tag Register whether payment received for Tags subject of notice.
